(19) United States
(12) Patent Application Publication
(10) Pub. No.: US 2026/0123600 A1
(43) Pub. Date: May 7, 2026

(54) Proprioceptive Materials for Pet Beds, Pet Carriers, and the Like

(71) Applicants: Michael Rudan, Niagara Falls (CA); Eric Villency, Jupiter, FL (US); Seamus Hall, New York, NY (US)

(72) Inventors: Michael Rudan, Niagara Falls (CA); Eric Villency, Jupiter, FL (US); Seamus Hall, New York, NY (US)

(21) Appl. No.: 19/382,242

(22) Filed: Nov. 6, 2025

Related U.S. Application Data
(60) Provisional application No. 63/717,405, filed on Nov. 7, 2024.

(51) Int. Cl. A01K 1/02; A45C 11/00; A45C 13/10

(52) U.S. Cl. CPC A01K 1/0254; A01K 1/0263; A45C 11/00; A45C 13/103; A45C 2013/1015

(57) ABSTRACT

Pet beds, pet carriers, and pet harnesses are discussed for providing a proprioceptive effect when a pet sits or lays thereon or placed thereon, as the case may be, comprising compressible materials that can be incorporated therein. The compressible materials can be made of one or more of rubber, thermoplastic rubber, foam rubber, polyurethane rubber, silicone rubber, thermoplastic resin and thermoplastic elastomer. Positioning the compressible material such that it is between the pet and any surface for example when sitting or laying thereon, requires the pet to maintain balance by using muscles that would not ordinarily be used, and provides proprioceptive feedback to the pet's central nervous system.

### CROSS-REFERENCE TO RELATED APPLICATIONS

This application claims priority of U.S. provisional patent Application Ser. No. 63/717,405 filed Nov. 7, 2024, entitled “Proprioceptive Materials for Pet Beds, Pet Carriers, and the Like,” and filed in the names of Michael Rudan et al., which is incorporated by reference into this application in its entirety.

### TECHNICAL FIELD

The present disclosure is related to the field of apparatuses comprising proprioceptive materials for a variety of surfaces, in particular, compressible proprioceptive materials that can be incorporated onto surfaces, furniture and other like objects to provide a proprioceptive effect when contacting the surfaces.

### BACKGROUND

It is often difficult for people who are not in the best of physical shape to improve their physical well-being and health. Also, those who were more physically active and fit when they were younger tend to become more sedentary as they age, and their physical well-being and health can decline. In addition, those who have suffered a physical injury, notwithstanding that they may have been physically fit and healthy prior to the injury, may find it difficult to continue exercising as they could prior to their injury. In all of these cases, there is a need for improved physical fitness footwear, apparel and equipment that can enable anyone to enhance their exercise regime by causing them to use additional muscles to maintain their balance while exercise while lowering the amount of weight or force required so as to not overtax the person's joints and muscles and improve proprioception, especially if they had been previously sedentary or are recovering from an injury.

In The Role of Proprioception in the Management and Rehabilitation of Athletic Injuries (SM Lephart et al., The American Journal of Sports Medicine, Vol. 25, No. 1) proprioception is defined as a specialized sensory modality of touch and encompasses the sensations of joint movement and joint position. Proprioception contributes to motor programing for neuromuscular control required for precision movements and also contributes to muscle reflexes, providing dynamic joint stability. Proprioceptive receptors found in the skin, muscles and joints provide input to the central nervous system (“CNS”) and, along with visual and vestibular centres, contributes afferent information to the CNS regarding body position and balance. A sports injury or other musculoskeletal trauma can lead to proprioceptive defects. Proprioceptive rehabilitation seeks to retrain altered afferent pathways to enhance sensation of joint movement. There is a need for improved physical fitness footwear, apparel and equipment that can enable anyone to train or retrain afferent pathways to improve functional stability of the person's joints and body.

It is, therefore, desirable to provide apparatuses comprising compressible materials that can be incorporated therein to provide a proprioceptive effect contacting surfaces, furniture and other like objects.

### SUMMARY

Apparatuses comprising compressible material is provided to provide a proprioceptive effect when contacted thereon. In some embodiments, the apparatuses can comprise the materials and devices as described in international patent application no. PCT/CA2017/050874 filed 20 Jul. 2017, which is incorporated by reference into this application in its entirety, as well as in international patent application no. PCT/CA2024/050252 filed 29 Feb. 2024, which is incorporated by reference into this application in its entirety.

In some embodiments, compressible protrusions can be added to seat pads, chairs, neck support devices, back or body part support devices, and pet beds. The addition of the compressible protrusions can operate to cause the user to actively hold the muscles, joints and body in a proper alignment providing proprioceptive feedback to the CNS. These voluntary movements can be repeated and stored as central commands. This patterning of the brain allows various skills to be performed without continuous without continuous reference to consciousness and can increase the conscious and unconscious awareness of the joint or limb in motion.

In some embodiments, the compressible hemispheres can be comprised of an elastomeric material, as well known to those skilled in the art. In some embodiments, the elastomeric material can comprise one or more of a group comprising of rubber, thermoplastic rubber, foam rubber, polyurethane rubber, silicone rubber, thermoplastic resin and thermoplastic elastomer. In further embodiments, the exterior of the compressible hemisphere can be composed of a durable material, such as plastic or synthetic fiber and the interior of the compressible protrusion can comprise one or more of a liquid, a gel and a gas, such as air or combinations thereof.

Broadly stated, in some embodiments, a pet bed can be provided for providing a proprioceptive effect for a pet sitting or laying thereon, the pet bed comprising: a base layer, the base layer comprising an upward-facing surface and a downward-facing surface; and a plurality of compressible protrusions disposed on the upward-facing surface, the plurality of compressible protrusions spaced apart from each other in a substantially uniform configuration.

Broadly stated, in some embodiments, each of the plurality of compressible protrusions can be substantially hexagonal in configuration.

Broadly stated, in some embodiments, each of the plurality of compressible protrusions can comprise one or more of a group comprising rubber, thermoplastic rubber, foam rubber, polyurethane rubber, silicone rubber, thermoplastic resin and thermoplastic elastomer.

Broadly stated, in some embodiments, the pet bed can further comprise a bed frame with a top surface and a bottom surface.

Broadly stated, in some embodiments, the bed frame can further comprise a plurality of legs extending downwardly from the bottom surface, wherein the downward-facing surface of the base layer is disposed on the top surface.

Broadly stated, in some embodiments, a bed rail can extend upwardly from a perimeter of the top surface, wherein the bed rail can extend at least partially around the perimeter.

Broadly stated, in some embodiments, a pet carrier can be provided for providing a proprioceptive effect for a pet sitting or laying thereon, comprising: a mat layer; a hood layer operatively attached to the mat layer; a pair of opposing end panels releasably attached to the mat layer and the hood layer; and a first fastening mechanism for releasably attaching the pair of opposing end panels to the mat layer and hood layer wherein fastening the pair of opposing end panels to the mat layer and hood layer forms an enclosed space for the pet.

Broadly stated, in some embodiments, wherein the mat layer can further comprise a plurality of compressible protrusions disposed on an upward-facing surface thereof, the plurality of compressible protrusions spaced apart from each other in a substantially uniform configuration.

Broadly stated, in some embodiments, each of the plurality of compressible protrusions of the pet bed can be substantially hexagonal in configuration.

Broadly stated, in some embodiments, each of the plurality of compressible protrusions of the pet bed can comprise one or more of a group comprising rubber, thermoplastic rubber, foam rubber, polyurethane rubber, silicone rubber, thermoplastic resin and thermoplastic elastomer.

Broadly stated, in some embodiments, the pet carrier can further comprise an opening disposed through the hood layer and a hatch for covering the opening.

Broadly stated, in some embodiments, the pet carrier can further comprise a second fastening mechanism for releasably attaching the hatch to the hood layer.

Broadly stated, in some embodiments, one or both of the first and the second fastening mechanism can comprise one or both of a group comprising zippers and hook and loop fasteners.

Broadly stated, in some embodiments, a pet harness can be provided for providing a proprioceptive effect for a pet when placed thereon, comprising: a back plate; a chest plate; two or more sets of straps operatively coupling the chest plate to the back plate wherein the combination thereof is configured for being placed on a body of the pet; a first layer of a first plurality of compressible protrusions facing downwardly disposed on a bottom surface of the back plate; and a second layer of a second plurality of compressible protrusions facing upwardly disposed on a top surface of the chest plate.

Broadly stated, in some embodiments, each of the compressible protrusions of one or both of the first and the second plurality of compressible protrusions can be spaced apart from each other in a substantially uniform configuration.

Broadly stated, in some embodiments, each of the compressible protrusions of the first and the second plurality of compressible protrusions can be substantially hexagonal in configuration.

Broadly stated, in some embodiments, each of the compressible protrusions of the first and the second plurality of compressible protrusions can comprise one or more of a group comprising rubber, thermoplastic rubber, foam rubber, polyurethane rubber, silicone rubber, thermoplastic resin and thermoplastic elastomer.

### BRIEF DESCRIPTION OF THE DRAWINGS

FIG. 1 is a front perspective view depicting one embodiment of a seat pad comprising compressible protrusions thereon.

FIG. 2 is a top plan view depicting the seat pad of FIG. 1.

FIG. 3 is a front perspective view depicting the seat pad of FIG. 1 on a seat of a chair.

FIG. 4 is a perspective plan view depicting a second embodiment of a seat pad comprising compressible protrusions thereon.

FIG. 5 is a front perspective view depicting a third embodiment of a seat pad comprising compressible protrusions thereon.

FIG. 6 is a side elevation view depicting the seat pad of FIG. 5.

FIG. 7 is a top plan view depicting the seat pad of FIG. 5.

FIG. 8 is a perspective view depicting an alternate embodiment of the seat pad of FIG. 5 comprising a compressible protrusion layer disposed on top of a base layer.

FIG. 9 is a perspective view depicting the seat pad of FIG. 7 with the compressible protrusion layer separated from the base layer.

FIG. 10 is a perspective view depicting a fourth embodiment of seat and back pads comprising compressible protrusions placed on a chair.

FIG. 11 is a perspective plan view depicting one embodiment of a head support device with a layer of compressible protrusions disposed thereon.

FIG. 12 is a side elevation plan view depicting the head support device of FIG. 11.

FIG. 13 is a top plan elevation view depicting the head support device of FIG. 11.

FIG. 14 is a perspective view depicting an alternate embodiment of the head support device of FIG. 11 having a compressible protrusion layer separated from a base layer.

FIG. 15 is a perspective view depicting a second embodiment of head support device of FIG. 11.

FIG. 16 is a front elevation view depicting the head support device of FIG. 15.

FIG. 17 is a perspective view depicting one embodiment of a body rest comprising compressible protrusions disposed thereon.

FIG. 18 is a front elevation view depicting a reclining chair comprising a layer of compressible protrusions disposed thereon.

FIG. 19 is a perspective view depicting the reclining chair of FIG. 18.

FIG. 20 is a perspective view depicting one embodiment of an elevated pet bed comprising a layer compressible protrusions disposed thereon.

FIG. 21 is a perspective view depicting a second embodiment of the pet bed of FIG. 20.

FIG. 22 is a perspective view depicting a one embodiment of a non-elevated pet bed comprising a layer compressible protrusions disposed thereon.

FIG. 23 is a partial front elevation view depicting the pet bed of FIG. 22.

FIG. 24 is a perspective view depicting a second embodiment of the pet bed of FIG. 22.

FIG. 25 is a perspective view depicting another embodiment of the elevated pet bed of FIG. 20 comprising a layer compressible protrusions disposed thereon.

FIG. 26 is a perspective view depicting one embodiment of a semi-enclosed pet bed.

FIG. 27 is a perspective view depicting one embodiment of a pet mat.

FIG. 28 is a close-up perspective view depicting the pet mat of FIG. 27.

FIG. 29 is a perspective view depicting one embodiment of a pet carrier.

FIG. 30 is a perspective view depicting the pet carrier of FIG. 29 in an open position placed on a car seat having a pet sitting thereon.

FIG. 31 is a perspective view depicting the pet carrier of FIG. 30 in an open position without a pet sitting thereon.

FIG. 32 is a perspective view depicting the pet carrier of FIG. 29 shown in a closed position with a hatch portion open thereon.

FIG. 33 is a side elevation view depicting a pet leash having compressible protrusions on a handle thereof.

FIG. 34 is a close-up view depicting the pet leash of FIG. 33.

FIG. 35 is a front perspective view depicting a pet harness.

FIG. 36 is a rear perspective view depicting the pet harness of FIG. 35.

FIG. 37 is a perspective view depicting the pet harness of FIG. 35 as placed on a pet.

### DETAILED DESCRIPTION OF EMBODIMENTS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The presently disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

While the following terms used herein are believed to be well understood by one of ordinary skill in the art, definitions are set forth to facilitate explanation of the presently disclosed subject matter.

Unless defined otherwise, all technical and scientific terms used herein have the same meaning as commonly understood by one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in this application, including the claims.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about”, when referring to a value or to an amount of mass, weight, time, volume, concentration or percentage is meant to encompass variations of in some embodiments +/−50%, in some embodiments +/−40%, in some embodiments +/−30%, in some embodiments +/−20%, in some embodiments +/−10%, in some embodiments +/−5%, in some embodiments +/−1%, in some embodiments +/−0.5%, and in some embodiments +/−0.1% from the specified amount, as such variations are appropriate to perform the disclosed method.

Alternatively, the terms “about” or “approximately” can mean within an acceptable error range for the particular value as determined by one of ordinary skill in the art, which will depend in part on how the value is measured or determined, i.e., the limitations of the measurement system. For example, “about” can mean within 3, or more than 3, standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Unless otherwise indicated, all numbers expressing quantities, properties, and so forth used in the specification and claims are to be understood as being modified in all instances by the term “about”. And so, the numerical parameters set forth in this specification and claims are approximations that can vary depending upon the desired properties sought to be obtained by the presently disclosed subject matter.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

In some embodiments, a compressible protrusion can be provided. The compressible protrusion can comprise a planar surface and a protrusion from said planar surface. The compressible protrusion can be configured to be disposed between a person and a piece of exercise equipment or any hard surface. A plurality of the compressible protrusions can be configured into a layer or pad such that the it can be placed on a surface on a piece of furniture, on a device for supporting the neck or limb of a person, and on a pet bed.

In some embodiments, the compressible protrusion can comprise a hexagonal configuration whereby the spacing between the hexagonal compressible protrusions can comprise a substantially uniform width channel therebetween.

In some embodiments including those described herein, the compressible protrusions can improve the user's body positioning when performing exercises or other activities. The compressible protrusions can cause the user to actively hold the muscles, joints and body in a proper alignment providing proprioceptive feedback to the CNS (the “proprioceptive effect”). These voluntary movements can be repeated and stored as central commands. This patterning of the brain allows various skills to be performed without continuous without continuous reference to consciousness and can increase the conscious and unconscious awareness of the joint or limb in motion.

In some embodiments, including those described herein, the compressible protrusions can be comprised of an elastomeric material that has physical properties that enable it to be compressed under force and to substantially return to its original shape when the force is released. Such materials can include rubber, thermoplastic rubber, foam rubber, polyurethane rubber, silicone rubber, thermoplastic resin, thermoplastic elastomers and any other material having similar physical properties as well known to those skilled in the art. In further embodiments, the exterior of the compressible hemisphere can be composed of a durable material, such as plastic or synthetic fiber and the interior of the compressible protrusion can comprise one or more of a liquid, a gel and a gas, such as air.

In some embodiments, the compressible protrusions can comprise a low density that allows them to be compressed or be deformed so as to provide the proprioceptive effect to a person's body when exercising. In some embodiments, the compressible protrusions can comprise a high density that prevents or resists compression or deformation so as to provide an acupressure effect to a person's body when exercising.

Though the compressible protrusions in this application are at times described as hexagons, for the purposes of this specification and the claims herein, it shall be understood that any compressible protrusion described as a hemisphere or as being hemispherical can be substituted with other shapes such as a hemi-ovoid, hemi-ellipsoid, tetrahedron, trapezoidal prism or other similarly curved or polyhedral surface, or other suitable shape as well known to those skilled in the art.

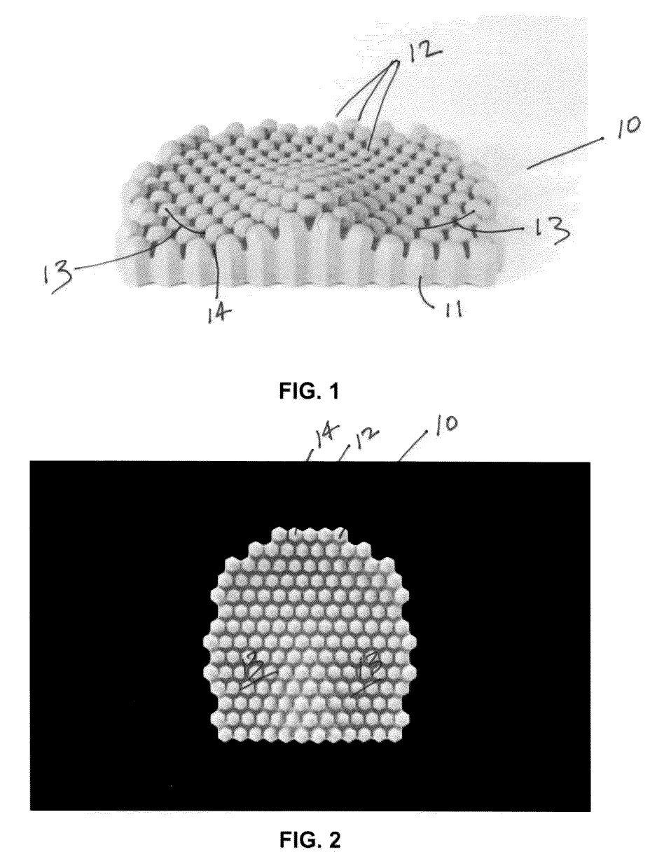

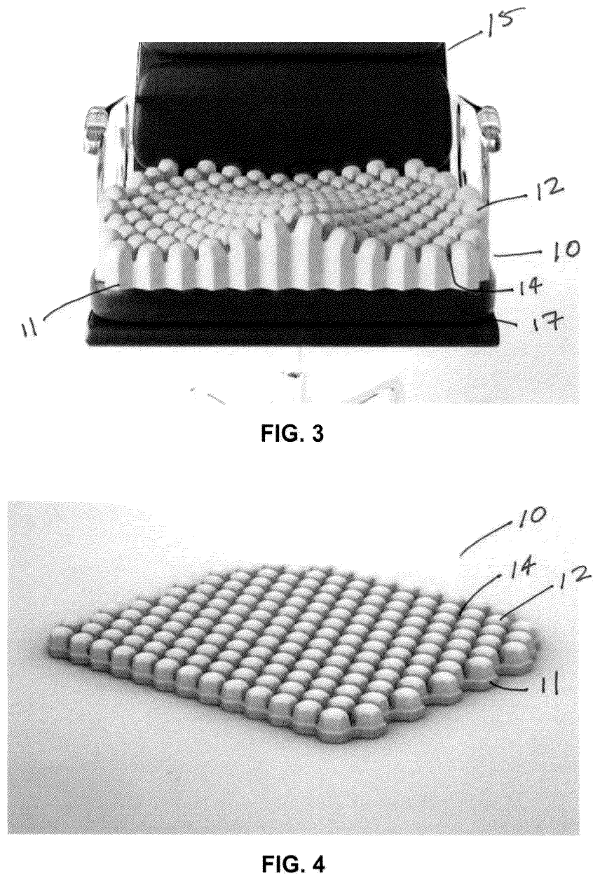

In some embodiments, a seat pad for a chair can be provided. Referring to FIGS. 1 to 3, one embodiment of seat pad 10 is shown. In some embodiments, seat pad 10 can comprise a plurality of spaced-apart hexagonal compressible protrusions 12 disposed thereon. In some embodiments, protrusions 12 can be spaced apart to form channel 14 therebetween wherein channel 14 can be substantially uniform in width throughout, which can provide sufficient space for protrusions 12 to expand into as it is deformed when weight is applied thereon to compress protrusions 12 causing them to decrease in height but increase in width. In some embodiments, seat pad 10 can be approximately 8 mm thick where base layer 11 can be approximately 4 mm thick and the height of protrusions 12 being approximately 4 mm. In some embodiments, seat pad 10 can comprise concave regions 13 disposed on a top surface thereof to accommodate the buttocks and thighs of a person sitting on seat pad 10. Referring to FIG. 3, in some embodiments, seat pad 10 can be placed on seat portion 17 of chair 15 to act as a cushion that can provide a proprioceptive effect that can be therapeutic to a person sitting thereon.

Referring to FIG. 4, a second embodiment of seat pad 10 is shown that does not comprise concave regions disposed on the top surface thereof wherein seat pad 10 can be placed on a hard or flat surface to act as a cushion that can provide a proprioceptive effect that can be therapeutic to a person sitting thereon.

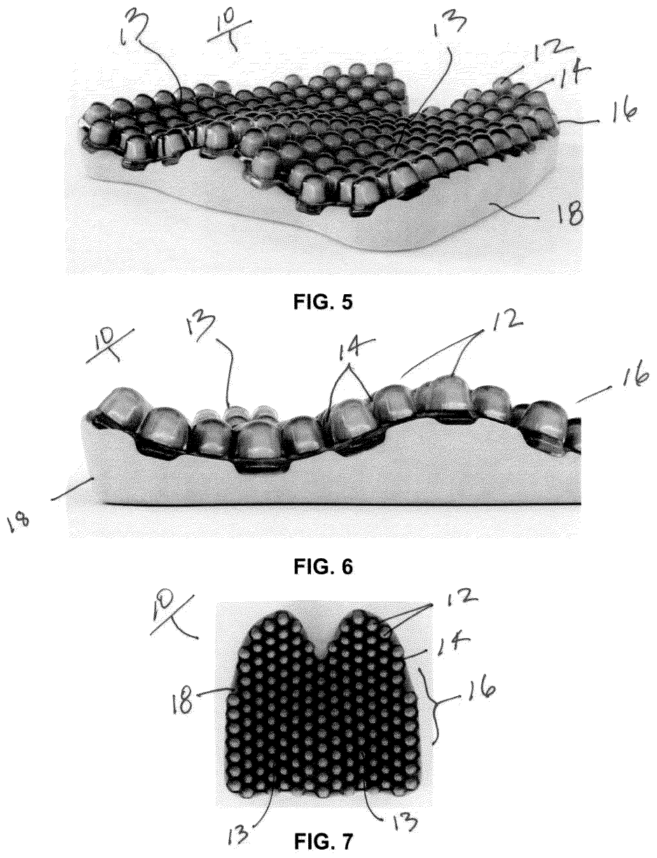

Referring to FIGS. 5 to 7, a second embodiment of seat pad 10 is shown wherein in this embodiment, seat pad 10 can be comprised of compressible protrusion layer 16 disposed on base layer 18, wherein layer 16 can comprise a plurality of compressible protrusions 12 disposed thereon having channels 14 disposed therebetween. In some embodiments, layers 16 and 18 can be comprised of similar elastomeric material having similar compression properties whereas in other embodiments, layers 16 and 18 can be comprised of different elastomeric material having differing compression properties. For example, in some embodiments, layer 16 can be comprised of softer or spongier elastomeric material allowing it to compress with minimal weight or force placed thereon whereas layer 18 can be comprised of firmer or stiffer elastomeric material requiring more weight or force placed thereon to compress it.

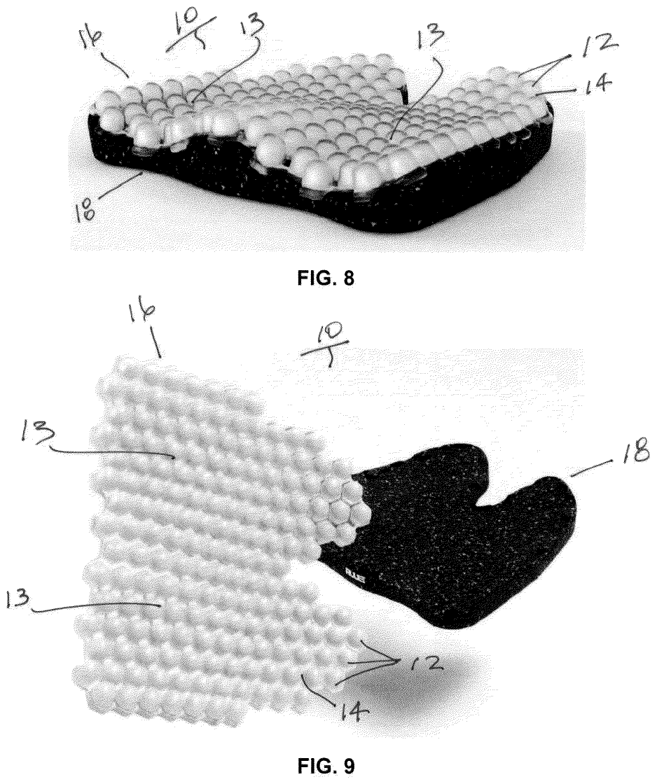

Referring to FIGS. 8 and 9, a further embodiment of seat pad 10 is shown, comprising compressible protrusion layer 16 that can be releasably attached to base layer 18. In some embodiments, base layer 18 can comprise firmer elastomeric material configured for receiving compressible protrusion layer 16 thereon. In some embodiments, multiple compressible protrusion layers 16, each having differing compression or firmness properties, can be used with base layer 18 such that the user can select a compressible protrusion layer 16 having a desired firmness.

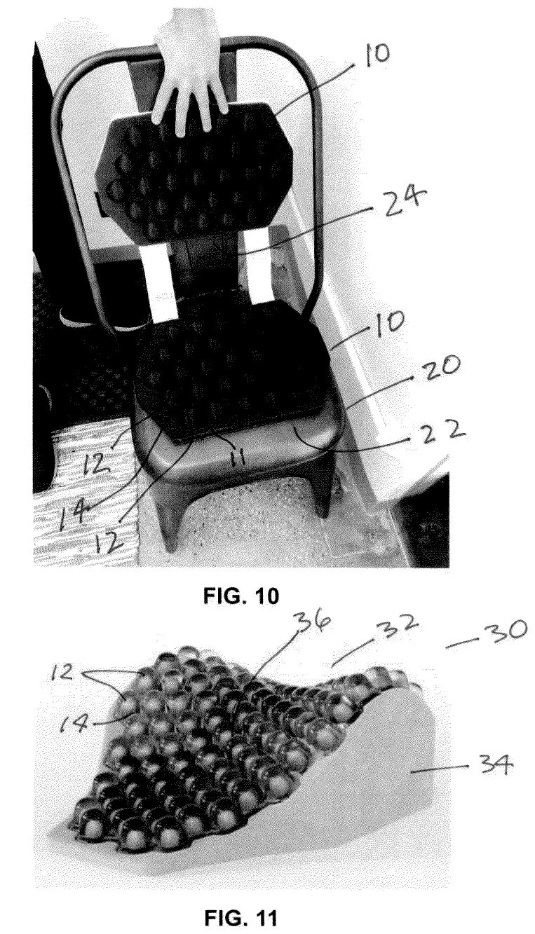

Referring to FIG. 10, a further embodiment of seat pad 10 placed on seat 22 and back 24 of chair 20. In this embodiment, each seat pad 10 can comprise a plurality of hemispherical compressible protrusions 12 disposed thereon, separated channels 14 running therebetween. In this embodiment, seat pads 10 can provide a cushioning, proprioceptive effect to both the buttocks and back of a person sitting on chair 20.

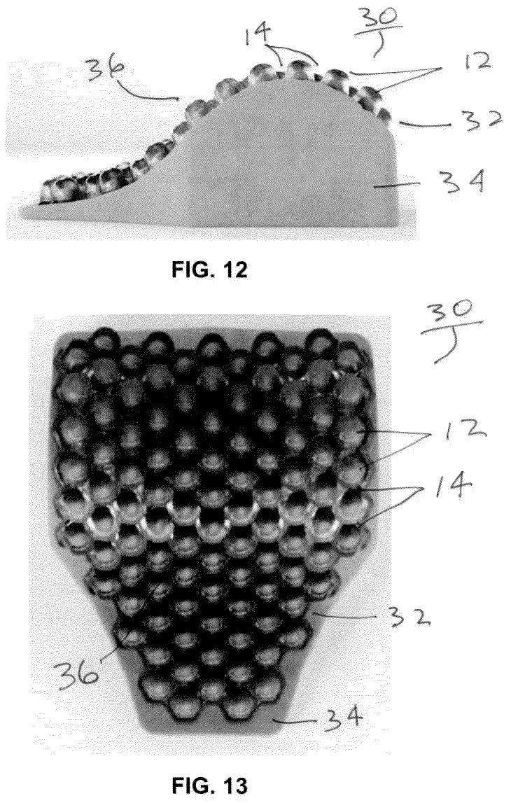

Referring to FIGS. 11 to 16, one embodiment of a head support device is shown. In some embodiments, head support device 30 can comprise of compressible protrusion layer 32 disposed on top on base layer 34. In some embodiments, compressible protrusion layer 32 can comprise a plurality of compressible protrusions 12 disposed thereon having channels 14 disposed therebetween. In some embodiments, the combination of layers 32 and 34 can comprise concave region 36 thereon that can be contoured to receive and support a neck and head of a person. In some embodiments, layers 32 and 34 can be comprised of similar elastomeric material having similar compression properties whereas in other embodiments, layers 32 and 34 can be comprised of different elastomeric material having differing compression properties. For example, in some embodiments, layer 32 can be comprised of softer or spongier elastomeric material allowing it to compress with minimal weight or force placed thereon whereas layer 34 can be comprised of firmer or stiffer elastomeric material requiring more weight or force placed thereon to compress it although in other embodiments, the converse can be true. In some embodiments, head support device 30 can provide a cushioning, proprioceptive effect to both the neck and head of a person laying their head on head support device 30.

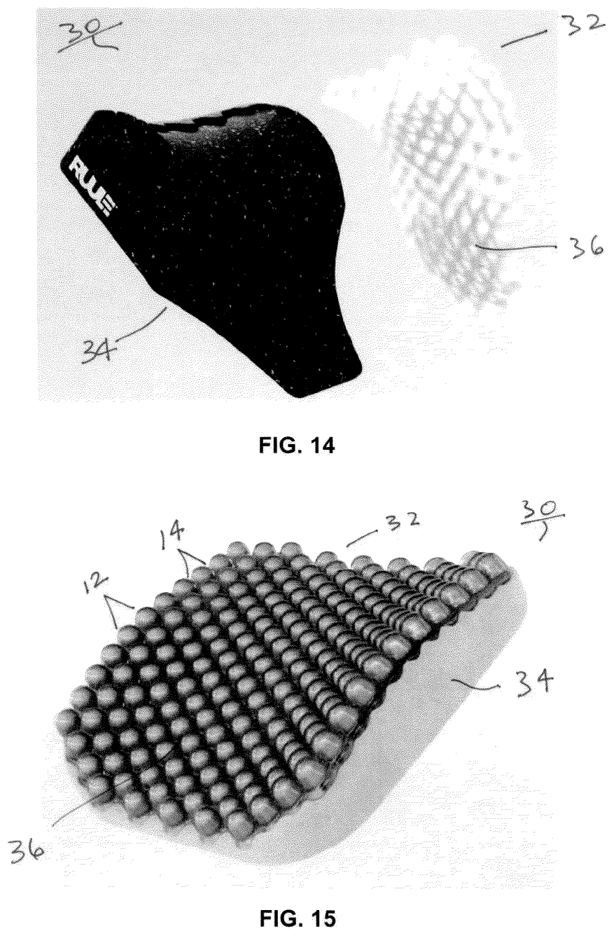

Referring to FIG. 14, an alternate embodiment of head support device 30 is shown. In this illustrated embodiment, in some embodiments, comprising compressible protrusion layer 32 can be releasably attached to base layer 34. In some embodiments, base layer 34 can comprise firmer elastomeric material configured for receiving compressible protrusion layer 32 thereon. In some embodiments, multiple compressible protrusion layers 32, each having differing compression or firmness properties, can be used with base layer 34 such that the user can select a compressible protrusion layer 32 having a desired firmness.

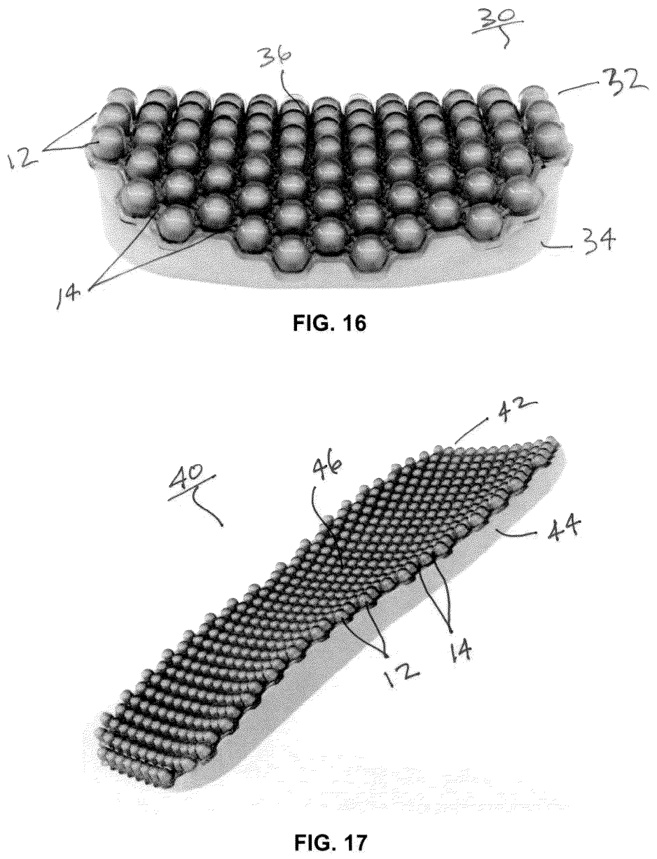

Referring to FIGS. 15 and 16, an alternate embodiment of head support device 30 having a different physical shape or configuration but comprising compressible protrusion layer 32 disposed on top on base layer 34. In some embodiments, compressible protrusion layer 32 can comprise a plurality of compressible protrusions 12 disposed thereon having channels 14 disposed therebetween. In some embodiments, the combination of layers 32 and 34 can comprise concave region 36 thereon that can be contoured to receive and support a neck and head of a person. In some embodiments, layers 32 and 34 can be comprised of similar elastomeric material having similar compression properties whereas in other embodiments, layers 32 and 34 can be comprised of different elastomeric material having differing compression properties. For example, in some embodiments, layer 32 can be comprised of softer or spongier elastomeric material allowing it to compress with minimal weight or force placed thereon whereas layer 34 can be comprised of firmer or stiffer elastomeric material requiring more weight or force placed thereon to compress it although in other embodiments, the converse can be true. In some embodiments, head support device 30 can provide a cushioning, proprioceptive effect to both the neck and head of a person laying their head on head support device 30.

Referring to FIG. 17, one embodiment of a body support device is shown. In some embodiments, body support device 40 can comprise of compressible protrusion layer 42 disposed on top on base layer 44. In some embodiments, compressible protrusion layer 42 can comprise a plurality of compressible protrusions 12 disposed thereon having channels 14 disposed therebetween. In some embodiments, the combination of layers 42 and 44 can comprise concave region 46 thereon that can be contoured to receive and support a person laying down thereon. In some embodiments, layers 42 and 44 can be comprised of similar elastomeric material having similar compression properties whereas in other embodiments, layers 42 and 44 can be comprised of different elastomeric material having differing compression properties. For example, in some embodiments, layer 42 can be comprised of softer or spongier elastomeric material allowing it to compress with minimal weight or force placed thereon whereas layer 44 can be comprised of firmer or stiffer elastomeric material requiring more weight or force placed thereon to compress it although in other embodiments, the converse can be true. In some embodiments, body support device 40 can provide a cushioning, proprioceptive effect to the back of a person laying down thereon.

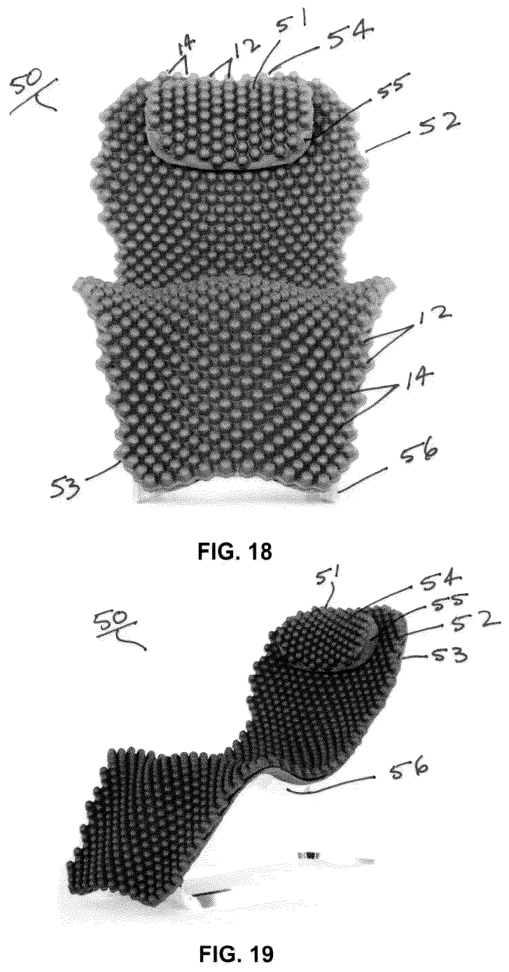

Referring to FIGS. 18 and 19, one embodiment of lounge chair 50 is shown. In some embodiments, lounge chair 50 can comprise compressible protrusion layer 52 disposed on chair frame 56, wherein lounge chair 50 can further comprise headrest 51 disposed on top of compressible protrusion layer 52. In some embodiments, compressible protrusion layer 52 can comprise a plurality of compressible protrusions 12 disposed thereon having channels 14 disposed therebetween, wherein compressible protrusions 12 can disposed on top of base layer 53. In some embodiments, layers 52 and 53 can be comprised of similar elastomeric material having similar compression properties whereas in other embodiments, layers 52 and 53 can be comprised of different elastomeric material having differing compression properties. For example, in some embodiments, layer 52 can be comprised of softer or spongier elastomeric material allowing it to compress with minimal weight or force placed thereon whereas layer 53 can be comprised of firmer or stiffer elastomeric material requiring more weight or force placed thereon to compress it although in other embodiments, the converse can be true.

In some embodiments, headrest 51 can comprise compressible protrusion layer 54 disposed on base layer 55. In some embodiments, compressible protrusion layer 54 can comprise a plurality of compressible protrusions 12 disposed thereon having channels 14 disposed therebetween, wherein compressible protrusions 12 can disposed on top of base layer 55. In some embodiments, layers 54 and 55 can be comprised of similar elastomeric material having similar compression properties whereas in other embodiments, layers 54 and 55 can be comprised of different elastomeric material having differing compression properties. For example, in some embodiments, layer 54 can be comprised of softer or spongier elastomeric material allowing it to compress with minimal weight or force placed thereon whereas layer 55 can be comprised of firmer or stiffer elastomeric material requiring more weight or force placed thereon to compress it although in other embodiments, the converse can be true.

In some embodiments, lounge chair 50 as illustrated and described above can provide a cushioning, proprioceptive effect to a person sitting or laying down thereon.

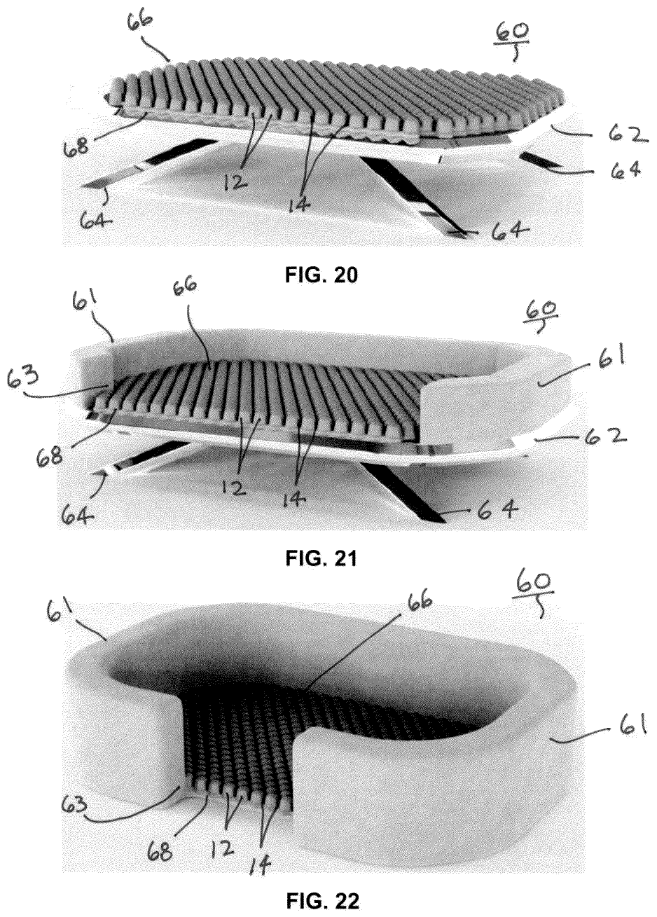

Referring to FIG. 20, one embodiment of pet bed 60 is shown. In some embodiments, pet bed 60 can comprise compressible protrusion layer 66 disposed on pet bed frame 62. In some embodiments, pet bed frame 62 can comprise a plurality of bed legs 64 extending downwardly from a bottom surface thereof to elevate compressible protrusion layer 66 above the ground. In some embodiments, compressible protrusion layer 66 can comprise a plurality of compressible protrusions 12 disposed thereon having channels 14 disposed therebetween, wherein compressible protrusions 12 can disposed on top of base layer 68. In some embodiments, layers 66 and 68 can be comprised of similar elastomeric material having similar compression properties whereas in other embodiments, layers 66 and 68 can be comprised of different elastomeric material having differing compression properties. For example, in some embodiments, layer 66 can be comprised of softer or spongier elastomeric material allowing it to compress with minimal weight or force placed thereon whereas layer 68 can be comprised of firmer or stiffer elastomeric material requiring more weight or force placed thereon to compress it although in other embodiments, the converse can be true. In some embodiments, pet bed 60 as illustrated in FIG. 20 and described above can provide a cushioning, proprioceptive effect to a pet sitting or laying down thereon.

Referring to FIG. 21, a second embodiment of pet bed 60 is shown. This illustrated embodiment is similar to the embodiment shown in FIG. 20 and described above except for the addition of bed rail 61 disposed partially around the perimeter of pet bed frame 62 forming opening 63 to form an opening for a pet to pass through to sit or lay upon compressible protrusion layer 66.

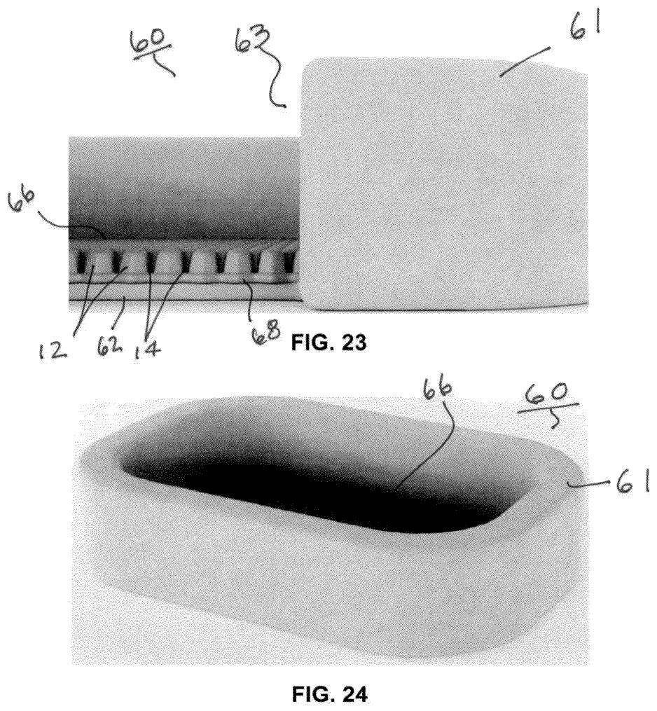

Referring to FIGS. 22 and 23, illustrated is an alternate embodiment of pet bed 60 as shown in FIG. 21. This illustrated embodiment is similar to the embodiment shown in FIG. 21 and described above except that this illustrated embodiment does not include bed legs 64 and, thus, this illustrated embodiment is configured to sit directly on the floor or ground.

Referring to FIG. 24, illustrated is yet a further embodiment of pet bed 60 as shown in FIGS. 22 and 23. This illustrated embodiment is similar to the embodiment shown in FIGS. 22 and 23 and described above except that bed rail 61 extends around the full perimeter of pet bed 60 and, thus, does not include opening 63 through bed rail 61.

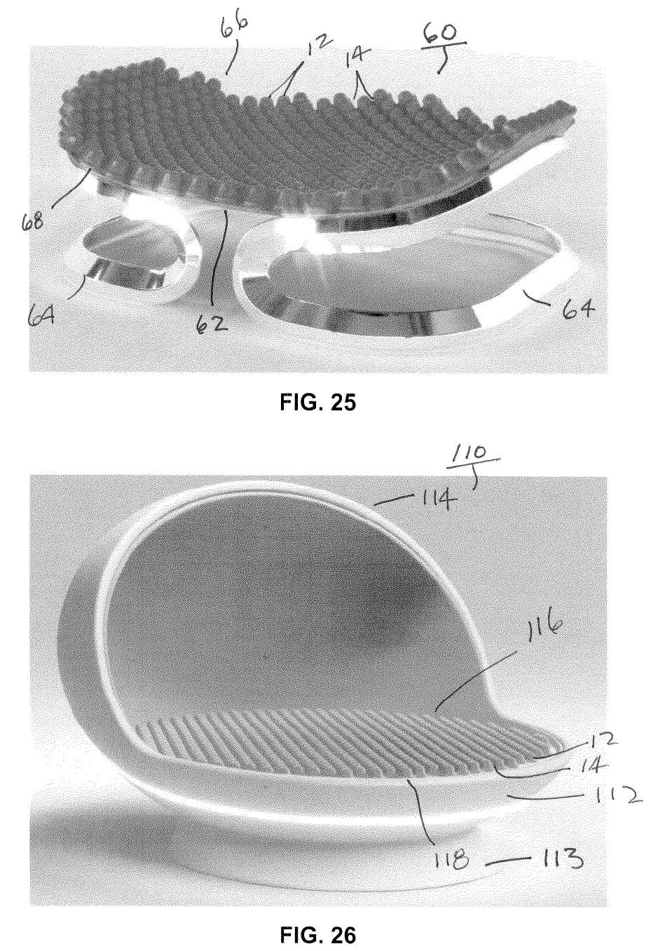

Referring to FIG. 25, an alternate embodiment of pet bed 60 shown in FIG. 20 is illustrated. In some embodiments, pet bed 60 can comprise compressible protrusion layer 66 disposed on curved pet bed frame 62. In some embodiments, pet bed frame 62 can comprise a plurality of bed legs 64 extending downwardly from a bottom surface of pet bed frame 62 to elevate compressible protrusion layer 66 above the ground. In some embodiments, compressible protrusion layer 66 can comprise a plurality of compressible protrusions 12 disposed thereon having channels 14 disposed therebetween, wherein compressible protrusions 12 can disposed on top of base layer 68. In some embodiments, layers 66 and 68 can be comprised of similar elastomeric material having similar compression properties whereas in other embodiments, layers 66 and 68 can be comprised of different elastomeric material having differing compression properties. For example, in some embodiments, layer 66 can be comprised of softer or spongier elastomeric material allowing it to compress with minimal weight or force placed thereon whereas layer 68 can be comprised of firmer or stiffer elastomeric material requiring more weight or force placed thereon to compress it although in other embodiments, the converse can be true. In some embodiments, pet bed 60 as illustrated in FIG. 24 and described above can provide a cushioning, proprioceptive effect to a pet sitting or laying down thereon.

Referring to FIG. 26, one embodiment of semi-enclosed pet bed 110 is shown. In some embodiments, pet bed 110 can comprise of pet bed base 112 disposed on top of pedestal 113 and semi-spherical hood 114 disposed on top of bed base 112 to partially enclose pet bed 110. In some embodiments, pet bed 110 can comprise compressible protrusion layer 116 disposed on pet bed base 112. In some embodiments, pedestal 113 can elevate compressible protrusion layer 116 above the ground. In some embodiments, compressible protrusion layer 116 can comprise a plurality of compressible protrusions 12 disposed thereon having channels 14 disposed therebetween, wherein compressible protrusions 12 can disposed on top of base layer 118. In some embodiments, layers 116 and 118 can be comprised of similar elastomeric material having similar compression properties whereas in other embodiments, layers 116 and 118 can be comprised of different elastomeric material having differing compression properties. For example, in some embodiments, layer 116 can be comprised of softer or spongier elastomeric material allowing it to compress with minimal weight or force placed thereon whereas layer 118 can be comprised of firmer or stiffer elastomeric material requiring more weight or force placed thereon to compress it although in other embodiments, the converse can be true. In some embodiments, pet bed 110 as illustrated in FIG. 26 and described above can provide a cushioning, proprioceptive effect to a pet sitting or laying down thereon.

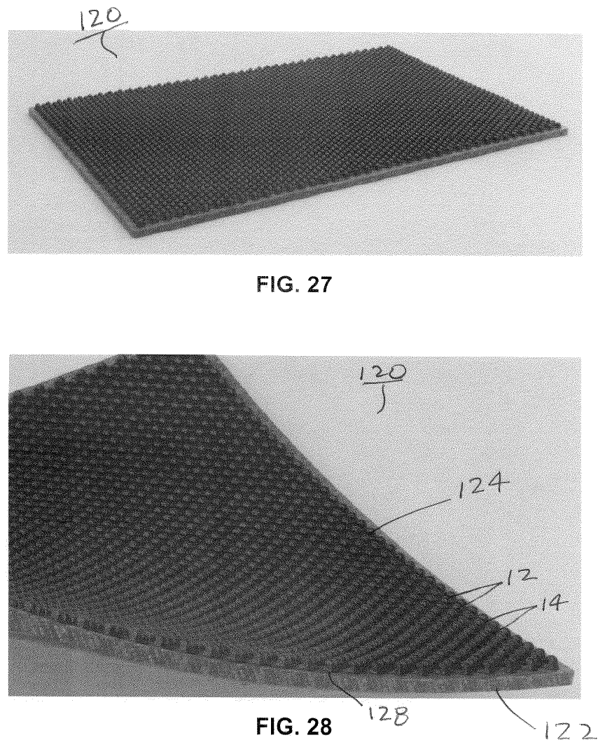

Referring to FIGS. 27 and 28, one embodiment of pet bed or mat 120 is shown. In some embodiments, pet bed or mat 120 can comprise of elastomeric base layer 122 can comprise compressible protrusion layer 124 disposed on base layer 122. In some embodiments, compressible protrusion layer 124 can comprise a plurality of compressible protrusions 12 disposed thereon having channels 14 disposed therebetween, wherein compressible protrusions 12 can disposed on top of base layer 128. In some embodiments, layers 124 and 128 can be comprised of similar elastomeric material having similar compression properties whereas in other embodiments, layers 124 and 128 can be comprised of different elastomeric material having differing compression properties. For example, in some embodiments, layer 124 can be comprised of softer or spongier elastomeric material allowing it to compress with minimal weight or force placed thereon whereas layer 128 can be comprised of firmer or stiffer elastomeric material requiring more weight or force placed thereon to compress it although in other embodiments, the converse can be true. In some embodiments, pet bed or mat 120 as illustrated and described above can provide a cushioning, proprioceptive effect to a pet sitting or laying down thereon.

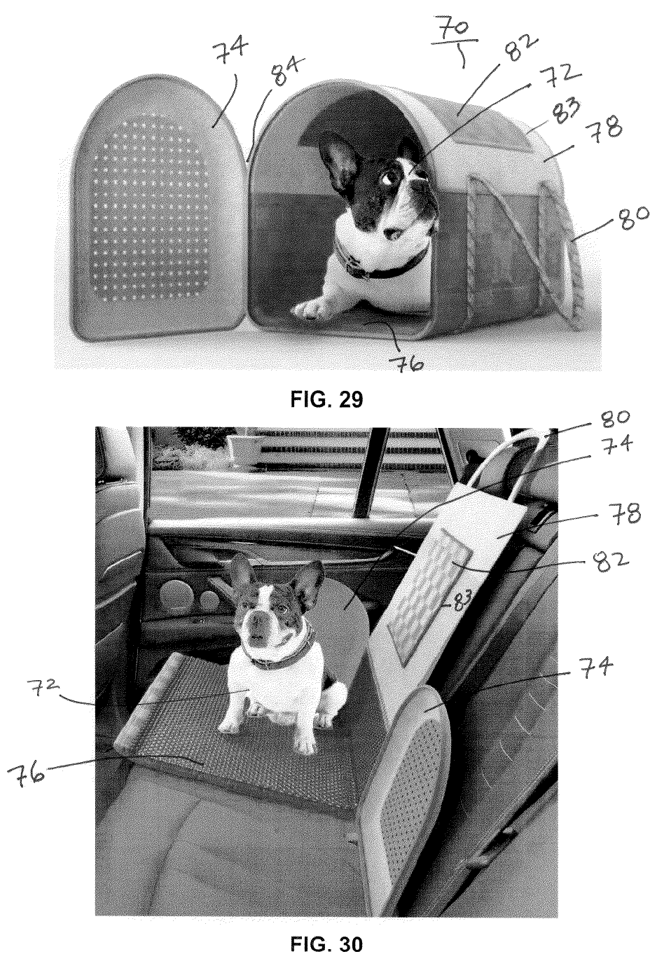

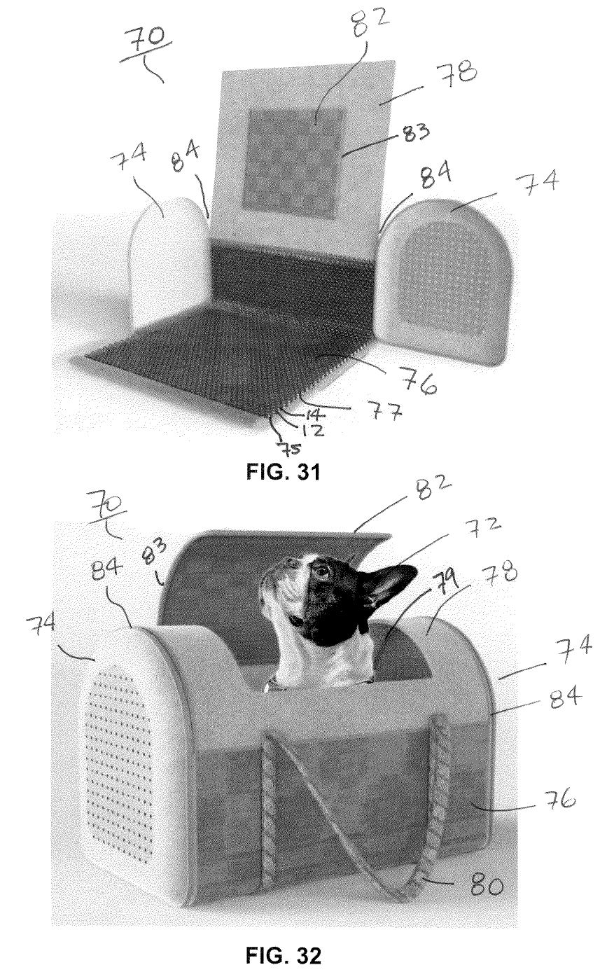

Referring to FIGS. 29 to 32, one embodiment of pet carrier 70 is shown. In some embodiments, pet carrier 70 can comprise of mat layer 76 operatively attached to hood layer 78, further comprising opposing end panels 74 releasably attached thereto. In some embodiments, end panels 74 can be releasably fastened to mat layer 76 and hood layer 78 with releasable fasteners 84, such as a zipper, a hook and loop fastener, or any other form of releasable fasteners as well known to those skilled in the art can be used, to form a closed structure for holding or carrying a pet as shown in FIGS. 29 and 32. In some embodiments, releasable fasteners 84 can be unfastened allowing one side of mat layer 76 to fold down and for hood layer 78 to be pulled back, as shown in FIGS. 30 and 31, to form a mat structure or bed for a pet to sit or lay thereon. This can allow pet carrier 70 to transform into a pet mat or bed that can be placed in a vehicle, or in any other location, for a pet to sit or lay on. In some embodiments, hood layer 78 can further comprise hatch 82 covering opening 79 disposed through hood layer 82 wherein hatch 82 can be releasably attached to hood layer 78 with releasable fastener 83, which can comprise a zipper, a hook and loop fastener, or any other form of releasable fasteners as well known to those skilled in the art. Opening 79 can provide means to place or remove a pet into or out of pet carrier 70, or to provide an opening for the pet to stick their head out for their comfort. Opening 79 can be closed by folding hatch 82 over top of opening 79 and then operating releasable fastener 83 to releasably attach hatch 82 to hood layer 78. In some embodiments, mat layer 76 can comprise compressible protrusion layer 77 disposed thereon. In some embodiments, compressible protrusion layer 77 can comprise a plurality of compressible protrusions 12 disposed thereon having channels 14 disposed therebetween, wherein compressible protrusions 12 can disposed on top of base layer 75. In some embodiments, layers 77 and 75 can be comprised of similar elastomeric material having similar compression properties whereas in other embodiments, layers 77 and 75 can be comprised of different elastomeric material having differing compression properties. For example, in some embodiments, layer 77 can be comprised of softer or spongier elastomeric material allowing it to compress with minimal weight or force placed thereon whereas layer 75 can be comprised of firmer or stiffer elastomeric material requiring more weight or force placed thereon to compress it although in other embodiments, the converse can be true. In some embodiments, pet carrier 70 as illustrated and described above can provide a cushioning, proprioceptive effect to a pet sitting or laying down thereon or when being carried therein.

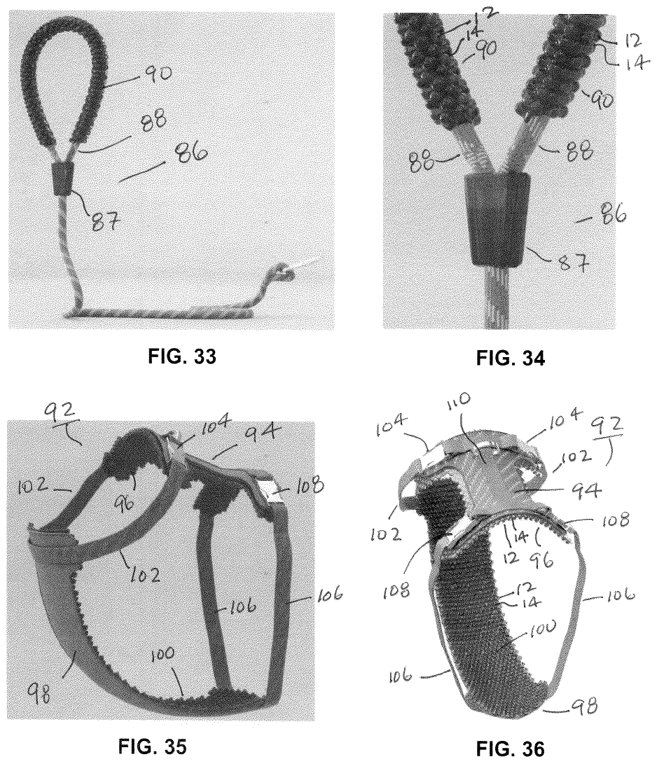

Referring to FIGS. 33 and 34, shown is one embodiment of pet leash 86 comprising of cord 88, noose 87 for forming cord 88 into a loop handle and handle cover 90 disposed on cord 88 wherein handle cover 90 can comprise of a plurality of compressible protrusions 12 thereon having channels 14 disposed therebetween. In some embodiments, protrusions 12 can be comprised of a compressible, elastomeric material, similar to the embodiments described above, that can provide a cushioning, proprioceptive effect when grasping handle cover 90.

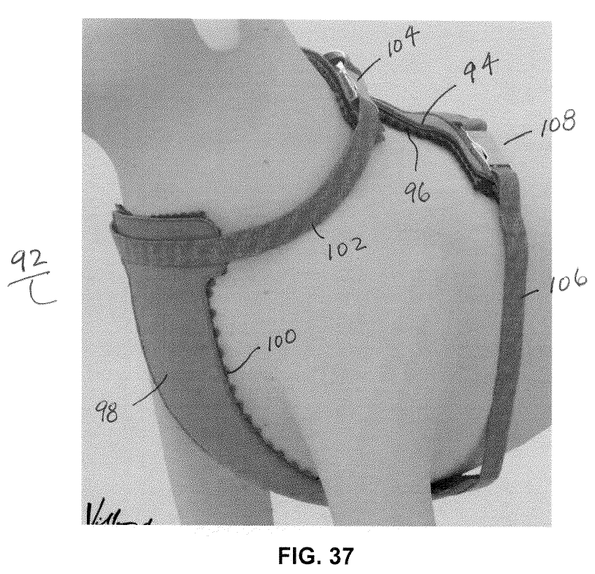

Referring to FIGS. 35 to 37, one embodiment of pet harness 92 for placing on the body of a pet is shown. In some embodiments, pet harness 92 can comprise of back plate 94 and chest plate 98 operatively coupled together. In some embodiments, forward straps 102 for placing around a neck of the pet and rear straps 106 for placing around a torso of the pet can be operatively attached to chest plate 98 wherein straps 102 and 106 can be releasably attached to back plate 94 with buckles 104 and 108, respectively. In some embodiments, one or more of back plate 94, chest plate 98, forward straps 102 and rear straps 106 can be comprised of one or more of leather, fabric, plastic, and other suitable materials for pet harnesses as well known to those skilled in the art. In some embodiments, back plate 94 can comprise compressible protrusion layer 96 disposed on a bottom surface thereof wherein layer 96 contacts a pet when harness 92 is attached to the pet, as shown in FIG. 37. In some embodiments, chest plate 98 can comprise compressible protrusion layer 100 disposed on a top surface thereof wherein layer 100 contacts a pet when harness 92 is attached to the pet, as shown in FIG. 37. In some embodiments, one or both of layers 96 and 100 can comprise of a plurality of compressible protrusions 12 thereon having channels 14 disposed therebetween. In some embodiments, protrusions 12 can be comprised of a compressible, elastomeric material, similar to the embodiments described above, that can provide a cushioning, proprioceptive effect to a pet when harness 92 is placed on the pet.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. A pet bed for providing a proprioceptive effect for a pet sitting or laying thereon, the pet bed comprising:
a) a base layer, the base layer comprising an upward-facing surface and a downward-facing surface; and
b) a plurality of compressible protrusions disposed on the upward-facing surface, the plurality of compressible protrusions spaced apart from each other in a substantially uniform configuration.

2. The pet bed as set forth in claim 1, wherein each of the plurality of compressible protrusions is substantially hexagonal in configuration.

3. The pet bed as set forth in claim 1, wherein each of the plurality of compressible protrusions comprises one or more of a group comprising rubber, thermoplastic rubber, foam rubber, polyurethane rubber, silicone rubber, thermoplastic resin and thermoplastic elastomer.

4. The pet bed as set forth in claim 1, further comprising a bed frame with a top surface and a bottom surface.

5. The pet bed as set forth in claim 4, further comprising a plurality of legs extending downwardly from the bottom surface, wherein the downward-facing surface of the base layer is disposed on the top surface.

6. The pet bed as set forth in claim 5, further comprising a bed rail extending upwardly from a perimeter of the top surface, the bed rail extending at least partially around the perimeter.

7. A pet carrier for providing a proprioceptive effect for a pet sitting or laying thereon, comprising:
a) a mat layer;
b) a hood layer operatively attached to the mat layer;
c) a pair of opposing end panels releasably attached to the mat layer and the hood layer; and
d) a first fastening mechanism for releasably attaching the pair of opposing end panels to the mat layer and hood layer wherein fastening the pair of opposing end panels to the mat layer and hood layer forms an enclosed space for the pet.

8. The pet carrier as set forth in claim 7, wherein the mat layer further comprises a plurality of compressible protrusions disposed on an upward-facing surface thereof, the plurality of compressible protrusions spaced apart from each other in a substantially uniform configuration.

9. The pet carrier as set forth in claim 8, wherein each of the plurality of compressible protrusions is substantially hexagonal in configuration.

10. The pet carrier as set forth in claim 8, wherein each of the plurality of compressible protrusions comprises one or more of a group comprising rubber, thermoplastic rubber, foam rubber, polyurethane rubber, silicone rubber, thermoplastic resin and thermoplastic elastomer.

11. The pet carrier as set forth in claim 7, further comprising an opening disposed through the hood layer and a hatch for covering the opening.

12. The pet carrier as set forth in claim 11, further comprising a second fastening mechanism for releasably attaching the hatch to the hood layer.

13. The pet carrier as set forth in claim 7, wherein the first fastening mechanism comprises one or both of a first group comprising zippers and hook and loop fasteners.

14. The pet carrier as set forth in claim 12, wherein the second fastening mechanism comprises one or both of a second group comprising zippers and hook and loop fasteners.

15. The pet carrier as set forth in claim 7, further comprising at least one handle attached thereto for carrying the pet carrier by hand.

16. A pet harness for providing a proprioceptive effect for a pet when placed thereon, comprising:
a) a back plate;
b) a chest plate;
c) two or more sets of straps operatively coupling the chest plate to the back plate wherein the combination thereof is configured for being placed on a body of the pet;
d) a first layer of a first plurality of compressible protrusions facing downwardly disposed on a bottom surface of the back plate; and
e) a second layer of a second plurality of compressible protrusions facing upwardly disposed on a top surface of the chest plate.

17. The pet harness as set forth in claim 16, wherein one or both of the first and the second plurality of compressible protrusions are spaced apart from each other in a substantially uniform configuration.

18. The pet harness as set forth in claim 16, wherein each of the first and the second plurality of compressible protrusions is substantially hexagonal in configuration.

19. The pet harness as set forth in claim 16, wherein each of the first and the second plurality of compressible protrusions comprises one or more of a group comprising rubber, thermoplastic rubber, foam rubber, polyurethane rubber, silicone rubber, thermoplastic resin and thermoplastic elastomer.
